(19) United States
(12) Patent Application Publication
(10) Pub. No.: US 2007/0016739 A1
(43) Pub. Date: Jan. 18, 2007

(54) Data processing device and control method for the same

(75) Inventor: Yun-chul Na, Mokpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/482,800

(22) Filed: Jul. 10, 2006

(30) Foreign Application Priority Data
Jul. 12, 2005 (KR) 2005-62802

(51) Int. Cl. G06F 13/28; G06F 11/00; G06F 12/16

(52) U.S. Cl. 711/158; 714/38; 711/162

(57) ABSTRACT

The present invention provides a data processing device and a method for processing data. The data processing device comprises a first memory for storing data, a second memory for storing programs and backup data, and a controller for reading the data based on a priority order and for executing one or more applications. Accordingly, the present invention provides a data processing unit and a control method capable of decreasing a probability of error occurrence during execution of an application.

### CROSS-REFERENCE TO RELATED APPLICATIONS

This application claims the benefit under 35 U.S.C. §119(a) of Korean Patent Application No. 2005-0062802, filed on Jul. 12, 2005, in the Korean Intellectual Property Office, the entire disclosure of which is hereby incorporated by reference.

### BACKGROUND OF INVENTION

1. Field of Invention

The present invention relates to a data processing device and a control method for the same. More particularly, the present invention relates to a data processing device and control method for executing an application by reading data.

2. Description of the Related Art

An electronic device such as a TV comprises a main memory unit such as a central processing unit (CPU), which stores programs for executing applications, and an auxiliary memory unit, which stores various kinds of data for driving the electronic device. The CPU storing the program also stores certain data for driving the electronic device. Other data are obtained by reading the auxiliary memory unit which has a larger storage capacity.

The data are read and written by inter-integrated circuit (I2C) type communication between the main memory unit such as the CPU and the auxiliary memory unit such as an EEPROM. During the reading and writing of data, a disturbance of the communication may occur due to an external noise or the like. If such a disturbance occurs, an error in which the CPU reads entirely different data, namely unwanted data from the auxiliary memory unit, may also occur. However, since the CPU recognizes data of the auxiliary memory unit as credible information, it does not recognize when the input data is wrong. Furthermore, since the CPU reads the data in the order in which it is stored in the auxiliary memory unit, it may not read the data which have to be read for proper execution of a program of the main memory unit. For example, in initially driving a power source for a TV, the screen may not be entirely displayed if the data communication is not smooth. Furthermore, improper data communication may lead to a latch state in which the screen is stopped by the error entirely.

Moreover, as the tendency of incorporating multi-functions into a single chip has accelerated, the probability of error occurrence has increased. The tendency of adding multi-functions onto a single chip means that individual programs for executing an application, for example a video or a sound program, are integrated into a single chip.

Accordingly, there is a need for an improved data processing device and method for controlling the improved data processing device.

### SUMMARY OF THE INVENTION

Exemplary embodiments of the present invention address at least the above problems and/or disadvantages and provide at least the advantages described below. Accordingly, an aspect of the present invention is to provide a data processing unit and a control method thereof that are capable of decreasing the probability of error occurrence when executing an application.

The foregoing and/or other exemplary aspects of the present invention can be achieved by providing a data processing device, comprising a first memory that stores data, a second memory that stores programs and backup data, and a controller that reads the data based on a priority order and executes an application.

According to an exemplary aspect of the present invention, the more frequently the data are changed by a user, the higher the priority that is assigned to the data.

According to an exemplary aspect of the present invention, the controller determines whether the data corresponds to the backup data and stores the data in the second memory if the data corresponds to the backup data.

According to an exemplary aspect of the present invention, the first memory comprises a first storage domain and a second storage domain, and the same data are stored in the first storage domain and the second storage domain separately.

According to an exemplary aspect of the present invention, the data having the priority order are stored in at least one of the first storage domain and the second storage domain.

According to an exemplary aspect of the present invention, the controller stores the data corresponding to the backup data in the storage domain in which is stored data that is different from the backup data in a case that the data stored in the first storage domain and the second storage domain are different from each other.

According to an exemplary aspect of the present invention, the controller reads the data stored in the second memory and thereby executes an application.

According to an exemplary aspect of the present invention, the controller reads the data and then executes an application in case that the data corresponds to the backup data.

According to an exemplary aspect of the present invention, the first memory comprises an EEPROM.

The foregoing and/or other exemplary aspects of the present invention can also be achieved by providing a control method of a data processing device, comprising setting up a priority order of data, reading the data stored in a first memory based on the priority order and executing an application using the read data.

According to an exemplary aspect of the present invention, the control method further comprises determining whether the data corresponds to backup data stored in a second memory between reading the data and executing an application.

According to an exemplary aspect of the present invention, the controller determines whether the data corresponds to the backup data and then stores the backup data in the first memory in case that the data does not correspond to the backup data.

It is to be understood that both the foregoing general description and the following detailed description are exemplary and explanatory and are intended to provide further explanation of the invention as claimed.

### BRIEF DESCRIPTION OF THE DRAWINGS

These and other objects, aspects, features, and advantages of certain exemplary embodiments of the present invention will be more apparent and more readily appreciated from the following detailed description, taken with reference to the accompanying drawings, in which:

FIG. 1 is a schematic control block diagram of a data processing device according to a first exemplary embodiment of the present invention;

FIG. 2 is a schematic control block diagram of a data processing device according to a second exemplary embodiment of the present invention;

FIG. 3 is a control flowchart for executing a control method of a data processing device according to the second exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

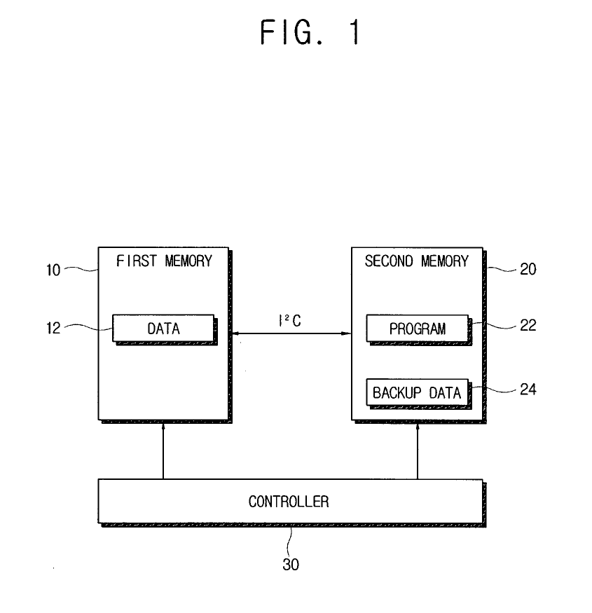

FIG. 1 is a schematic control block diagram of a data processing device according to a first exemplary embodiment of the present invention. As shown in FIG. 1, a data processing device comprises a first memory 10, a second memory 20, and a controller 30 controlling a data communication therebetween. The data processing device according to an exemplary embodiment of the present invention can be applied to any electronic device having a driving system using an I2C communication. In the first exemplary embodiment, a TV is used as an example. Also, the exemplary data processing procedure is a procedure used to initially drive the TV.

Since capacity of a second memory 20 corresponding to an inner storage part of a central processing unit is limited, the electronic device such as the TV further comprises an auxiliary memory device which can easily read and write data. The first memory 10 of a first exemplary embodiment may comprise a non-volatile memory, desirably an EEPROM. Data 12, comprising information necessary for operating the TV, are stored in the first memory 10. The necessary information comprises data which is necessary to initially drive the TV and data which may be altered by a user.

The first memory 10 stores data corresponding to a state when the TV is turned-off. Specifically, the first memory 10 stores basic data of the TV such as a channel, a sound, a color adjustment and the like. When the TV is turned on, the first memory 10 offers the second memory 20 the data which is needed to drive the TV.

The second memory 20 is provided in the CPU and stores a program 22 and backup data 24. The program 22 is used for executing applications, for example the procedure used to initially drive the TV. The second memory 20 interchanges the data 12 with the first memory 10 through the I2C communication. When power is applied to the TV, the controller 30 executes the program 22 to operate the system. At that time, the second memory 20 reads out the data 12 necessary for operating the system from the first memory 10. The controller 30 stores in the second memory 20 the data read out for executing the application, from among the data stored in the first memory 10, wherein the read out data corresponds to the backup data 24. The second memory 20 may comprise a volatile memory to store the data read out for executing the application, from among the data stored in the first memory 10. The volatile memory may comprise RAM (random access memory). Moreover, the second memory 20 may comprise a non-volatile memory to store program and backup data. The non-volatile memory may comprise ROM (read only memory).

The controller 30 reads out the data 12 of the first memory 10 based on a priority order when power is applied to the TV. Conventionally, there is a problem in that data for the program 22, which is required by a user, is not read but different data is read because the controller 30 reads the data 12 in the order stored in the first memory 10. Also, it has been found that the error may occur due to a difference of time between the speed of executing the program and the speed of reading the data 12. However, a probability of occurrence of the error related to data communication when initially driving the TV can be decreased since the controller 30 reads the data 12 based on the priority order. The priority order of the data as above may be based on the frequency of induced errors in the past, or on the frequency of changes to data values made by a user. For example, in operating a TV, the data 12 changeable through a user's interface comprises a channel, a sound, brightness, tilt, contrast, sharpness and the like and have a high probability of inducing error in communication of the data.

The controller 30 gives the data 12 the priority order so that the data 12 is read preferentially according to the given priority order. In practice, according to an experimental result of reading out the data 12 based on the given priority order, the probability of data error was decreased to nearly zero percent. The procedure in which the controller 30 reads an address of the data 12 having the priority order and then selectively takes the data 12 may be referred to as “identify”.

The controller 30 stores the data 12 read from the first memory 10 in the second memory 20 as backup data 24 and executes the program 22 using the stored backup data 24.

In general, the controller 30 may be integrated into a module with the second memory 20 to form one chip. Here, although they are shown as divided blocks, it is not indicative that the controller 30 must be physically divided from the second memory 20.

According to another exemplary embodiment, the controller 30 may compare whether the data 12 of the first memory 10 corresponds to the backup data 24 or not. According to reading the data 12 based on the priority order, a probability of a data error is decreased. However, the controller 30, according to an exemplary embodiment of the present invention, compares the data 12 with the backup data 24 and then corrects it which reduces the probability of data error to zero.

Briefly, the controller 30 reads the data 12 of the first memory 10 based on the priority order when power is applied to the TV and the TV is initially driven. Thereafter, the controller 30 stores the read data 12 as backup data 24 to the second memory 20 and also executes the program 22 by using the backup data 24.

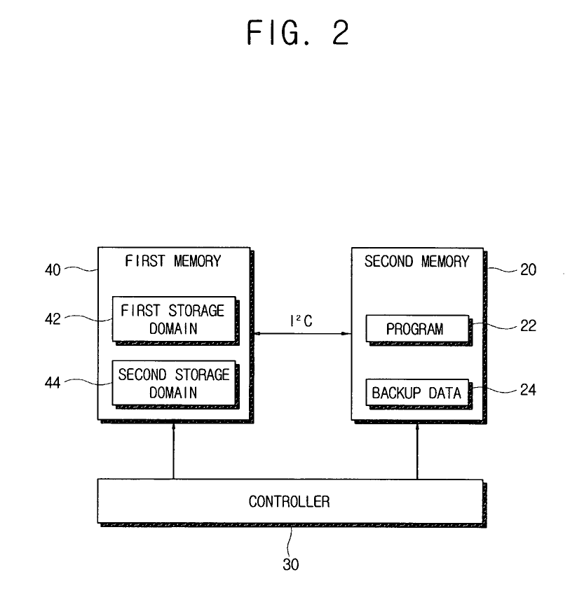

FIG. 2 is a schematic control block diagram of a data processing device according to a second exemplary embodiment of the present invention. Herein, since the second memory 20 and the controller 30 are the same as the data processing device of the previous exemplary embodiment as shown in FIG. 1, repeated explanations are abbreviated.

A first memory 40 according to an exemplary embodiment comprises a first storage domain 42 and a second storage domain 44. Data are stored in the first storage domain 42 and the second storage domain 44 separately. All data that must be stored in the first memory 40 may be stored in either the first storage domain 42 or the second storage domain 44 or both. In an exemplary embodiment, only the data having the priority order referred to in the previous exemplary embodiment are dually stored in the first and second storage domains 42 and 44. Dually storing only data having a high probability of causing an error and then using the data when executing an inspection for error is more efficient.

The controller 30 determines whether the data stored in the first memory 40, namely the first storage domain 42 and the second storage domain 44, corresponds to the backup data 24 stored in the second memory 20 or not. The backup data 24 of the second memory 20 is credible data stored in the CPU. Therefore, it is determined whether the data stored in the first memory 40 has an error or not based on the backup data 24.

In case that the data stored in the first storage domain 42 and the second storage domain 44 corresponds to the backup data 24, the controller 30 stores the data to the second memory 20 and executes an application by using it.

On the other hand, in case that one of the data stored in the first storage domain 42 and the second storage domain 44 does not correspond to the backup data 24, the controller 30 trusts the data corresponding to the backup data 24 and stores it to the storage domain in which had been stored the data which does not correspond to the backup data 24. Thereafter, the application is executed by using the data stored.

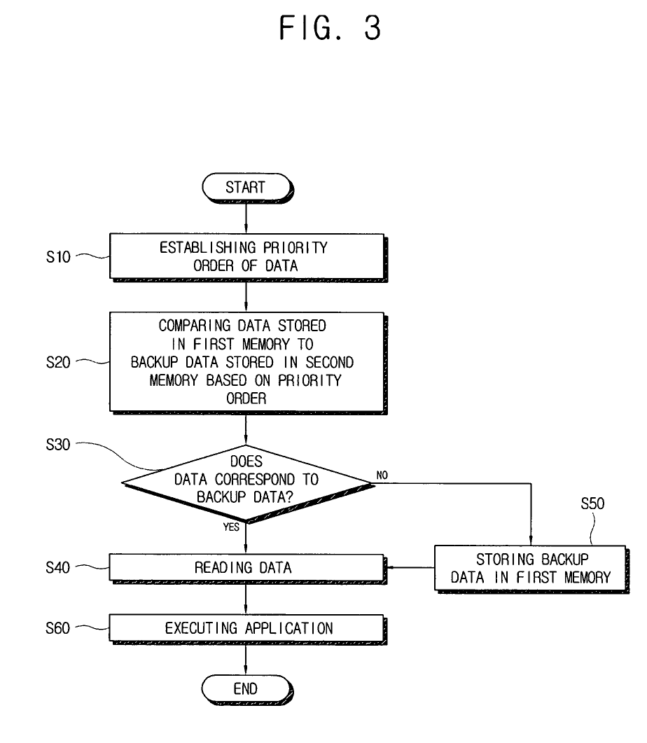

FIG. 3 is a flowchart of a method for operating a data processing device according to a second exemplary embodiment of the present invention.

A priority order of data is established based on a frequency with which most data errors occurred through a simulation or the like at operation S10. The aforementioned error may occur from the data that is changed frequently by a user and the corresponding probability of error is very high. A controller 30 determines whether the data stored in a first memory 40 corresponds to backup data 24 stored in a second memory 20 based on the priority order at operations S20 and S30. The first memory 40 comprises a first storage domain 42 and a second storage domain 44 and the same data which are as the backup data 24 are stored in each storage domain in case that the data error has not occurred.

In case that all the backup data 24 stored in the second memory 20 corresponds to the data stored in a first storage domain 42 and a second storage domain 44, the controller 30 reads the data of the first memory 40 at an operation S40 and thereby executes an application by using it at an operation S60.

However, in case that the backup data 24 stored in the second memory 20 does not correspond to the data stored in a first storage domain 42 and a second storage domain 44, the controller 30 stores the backup data 24 in the first memory 40, namely a storage domain where the data different from the backup data 24 has been stored at operation S50. Through these procedures, in case that the backup data 24 corresponds to the data of the first memory 40, the controller 30 executes the application based on it.

While the invention has been shown and described with reference to certain embodiments thereof, it will be understood by those skilled in the art that various changes in form and details may be made therein without departing from the spirit and scope of the invention as defined by the appended claims and the full scope of equivalents thereof.

What is claimed is:

1. A data processing device, comprising:
a first memory for storing data;
a second memory for storing backup data and a program for executing at least one application; and
a controller for reading the data based on a priority order and executing the at least one application.

2. The data processing device according to claim 1, wherein data that are frequently changed by a user have a higher priority.

3. The data processing device according to claim 1, wherein the controller determines whether the data corresponds to the backup data and stores the data in the second memory if the data corresponds to the backup data.

4. The data processing device according to claim 1, wherein the first memory comprises a first storage domain and a second storage domain, and at least the same data are stored in the first storage domain and the second storage domain separately.

5. The data processing device according to claim 4, wherein the data having the priority order are stored in one of the first storage domain and the second storage domain.

6. The data processing device according to claim 4, wherein the controller stores the data corresponding to the backup data in the second memory and the storage domain in which is stored the data different from the backup data in case that the data stored in the first storage domain and the second storage domain are different from each other.

7. The data processing device according to claim 6, wherein the controller reads the data stored in the second memory to execute the application.

8. The data processing device according to claim 5, wherein the controller stores the data corresponding to the backup data in the second memory and the storage domain in which is stored the data different from the backup data in case that the data stored in the first storage domain and the second storage domain are different from each other.

9. The data processing device according to claim 8, wherein the controller reads the data stored in the second memory to execute the application.

10. The data processing device according to claim 3, wherein the controller reads the data and then executes the application in case that the data corresponds to the backup data.

11. The data processing device according to claim 1, wherein the first memory is an EEPROM.

12. The data processing device according to claim 1, wherein the second memory is an RAM.

13. A control method of a data processing device, comprising:
establishing a priority order of data;
reading the data stored in a first memory based on the priority order; and
executing an application using the read data.

14. The control method according to claim 13, further comprising determining whether the data corresponds to backup data stored in a second memory between reading the data and executing the application.

15. The control method according to claim 13, further comprising storing the backup data in the first memory if the data does not correspond to the backup date.

16. The control method according to claim 14, further comprising storing the backup data in the first memory if the data does not correspond to the backup date.

17. The data processing device according to claim 1, wherein the controller executes the at least one application using the data in the priority order.

18. The control method according to claim 13, wherein the first memory is an EEPROM.

19. The data processing device according to claim 13, wherein the second memory is an RAM.
